(19) United States
(12) Patent Application Publication
(10) Pub. No.: US 2022/0331884 A1
(43) Pub. Date: Oct. 20, 2022

(54) CHUCK

(71) Applicant: SMW-Autoblok Spannsysteme GmbH, Meckenbeuren (DE)

(72) Inventors: Peter Helm, Meckenbeuren (DE); Emanuel Wolf, Markdorf (DE)

(21) Appl. No.: 17/720,533

(22) Filed: Apr. 14, 2022

(30) Foreign Application Priority Data
Apr. 14, 2021 (EP) 21 168 250.5

(51) Int. Cl. B23B 31/177

(52) U.S. Cl. CPC B23B 31/16254; B23B 31/16287

(57) ABSTRACT

A chuck (1) is provided by means of which workpieces (2) are supported individually for machining by a machine tool (3) and aligned coaxially to a centering axis (4), which serves as a reference for machining the workpiece (2) by the machine tool (3), having a chuck body (5), having at least four clamping jaws (6, 7, 8, 9) that are radially movably mounted on the chuck body (5) and are arranged in pairs in an X or Y plane and by means of which the workpiece (2) is held during the machining process to be aligned with respect to the centering axis (4), and having a pull piston (45) that is mounted in or at the chuck body (5) so as to be linearly movable and which is drivably coupled to a respective clamping jaw (6, 7, 8, 9) such that during the linear movement of the pull piston (45) the clamping jaws (6, 7, 8, 9) are radially fed in the direction of the workpiece (2) to be clamped or moved away from same in a synchronous manner, wherein the pull piston (45) is arranged coaxially with respect to the centering axis (4) inside the chuck body (5) and is axially actuated by one or more drive means (12, 13, 52, 53), on the one hand aiming at adjusting the compensatory movements between two adjacent clamping jaws running perpendicular to one another (6, 7, 8, 9) irrespective of their feed movement and operative contact with the workpiece (2) to be clamped, and on the other hand aiming at the constructional height of such chuck (1) being as small as possible. This aim is achieved in that each drive means (12, 13, 52, 53) has a linearly movable piston rod (26) or threaded spindle (55), whose respective longitudinal axis (26′ or 55′) is arranged to be perpendicular to the centering axis (4). (FIG. 1)

### REFERENCE TO PENDING PRIOR PATENT APPLICATION

This patent application claims benefit of European Patent Application No. 21 168 250.5, filed Apr. 14, 2021, which patent application is hereby incorporated herein by reference.

### FIELD OF THE INVENTION

The invention refers to a chuck by means of which workpieces are supported individually for machining by a machine tool and aligned coaxially with respect to a centering axis that serves as a reference for machining the workpiece, in accordance with the pre-characterising part of claim 1.

### BACKGROUND OF THE INVENTION

For example, such clamping device, which is known under the technical term chuck, can be found in DE 10 2015 204 502 B4. Between the base jaws and a mechanically operable drive unit, a rocker and a driver are provided, each of which is drivingly connected to one of the rockers. The drivers are drivingly coupled with an axially movable pressure piston via a coupling ring so that the actuating force of the pressure piston acts upon the driver. The axial movements of the driver and the coupling part generate a radially directed feed movement for the clamping jaws as these are coupled to the driver and supported so as to be movable in a guide groove.

Since clamping a workpiece by means of two pairs of diametrically opposite clamping jaws represents a mechanical overdetermination, the motion sequence between the clamping jaws, the drivers and the coupling part and the workpiece has to be compensated for where applicable. Namely, if one of the pairs of clamping jaws strikes the workpiece to be clamped earlier, its feed movement must be stopped in order to ensure that the clamping jaws running perpendicular to it can cover the remaining distance between themselves and the surface of the workpiece. A corresponding clamping force should only be generated when all of the four clamping jaws are in contact with the surface of the workpiece should. The motion clearance thus serves as compensation for the clamping jaws when they are moved in the direction of the workpiece. Especially if the workpieces have a rectangular outer contour so that their side lengths are dimensioned differently, it is necessary to compensate for these different distances between the pairs of diametrically opposed clamping jaws.

However, due to the required motion clearance, a considerable inaccuracy for the clamping position often occurs so that the positioning of the workpiece is incorrect. This in turn leads to incorrect processing of the workpiece itself as the repeat accuracy of the clamping of a large number of identical workpieces cannot be guaranteed.

Disadvantageously, however, such movement possibilities often result in considerable tolerance deviations with regard to the clamping effect, so that the required clamping force is not exactly predictable or predeterminable. Namely, the existing motion clearances between the components arranged in the powerflow lead to a relative motion between these components.

### SUMMARY OF THE INVENTION

These disadvantages have been realized by the applicant and remedied by their own development as described in EP 3 623 085 A1. The chuck of this document has a chuck body provided with a rocker disposed between two adjacent clamping jaws, respectively, by means of which a movement compensation between the two clamping jaws is effected, in particular whenever one of the clamping jaws comes into earlier operative contact with the workpiece to be clamped, spatially or temporally, than the other clamping jaw. Even though the axial feed movement of the drive means is transmitted to the respective clamping jaws via corresponding helical gearings, inclined surfaces or a grab-hook connection, the workpieces to be clamped may, on the one hand, have a rectangular or other cross-sectional contour, so that two opposed clamping jaws come into operative contact with the workpiece prior to the clamping jaws extending perpendicularly to them or, on the other hand, the workpieces initially are not in coaxial alignment with the centering axis serving as a reference and due to the feed movement of the four synchronously driven clamping jaws, the positioning of the workpiece to be clamped is achieved.

What is to be considered disadvantageous about the arrangement according to the above-mentioned patent application is that the drive means are coaxially aligned with the longitudinal axis of the chuck body so that they consequently require a considerable constructional space, which moreover is directly located in the working area of the machine tool. Namely, the chucks usually are fixed to a palette or a machine tool table and the workpiece to be machined is pre-mounted to the chuck. The positioning of the chuck with regard to the reference of the machine tool is exactly predetermined and accordingly repeat-accurate in the removal or assembly of the chuck. Thus, as soon as the workpiece is aligned coaxially with the longitudinal axis of the chuck body by means of the four clamping jaws, it also extends coaxially with regard to the centering axis of the machine tool serving as a reference, which usually corresponds to the longitudinal axis of the chuck body. However, the pressure piston is arranged directly below the machining level.

However, it is often necessary that the spaces that are present in the working area of a machine tool are not present for such arrangement of the drive means.

Moreover, the compensation movements between two adjacent clamping jaws, which are provided as a form of compensation movement in prior art, cannot immediately be transferred to other chucks.

It is therefore the task of the present invention to further develop a chuck of the aforementioned type in such a way that on the one hand, compensation movements between two adjacent clamping jaws that run perpendicular to one another are compensated independent of their feed movement and operative contact with the workpiece to be clamped, and that, on the other hand, the constructional height of such chuck is as small as possible.

This task is solved by the features of the characterising part of patent claim 1.

Further advantageous embodiments of the invention can be inferred from the subordinate claims.

In that each drive means has a linearly movable piston rod or threaded spindle, whose respective longitudinal axis is arranged perpendicularly to the centering axis, the constructional height for such chucks is extremely small, since the drive means extend in particular within the plane formed by the chuck body, so that the constructional height in parallel to the centering axis is not affected by the spatial extension of the drive means. The length of the respective drive means does in fact not affect the constructional height of the chuck and even if the length of the drive means is dimensioned such that it extends beyond the outer edge of the chuck body, the constructional height of the chuck is not affected.

The spatial extension as well as the required axial movements of the drive means accordingly extend in a horizontal plane so that advantageously the constructional height of the chuck is not affected by the arrangement of the drive means as the drive means may extend beyond the outer edge of the chuck and consequently do not require any constructional space which extends in parallel with respect to the longitudinal axis of the chuck.

Due to construction measures, the axial movements of the drive means are redirected or transmitted to the clamping jaws in such a way that they can be moved synchronously towards the workpiece to be clamped in a radial direction and that simultaneously, the clamping process for all clamping jaws that are present can be initiated. Namely, the clamping jaws are drivingly coupled with at least one of the drive means via helical gearings or a wedge hook frame.

Therefore, the axial movements of the drive means are converted into radial feed or clamping movements of the clamping jaws inside the chuck body.

In case of the presence of several drive means for the respective movement of the clamping jaws, these are synchronised with one another by means of a synchronizer ring in order to ensure that both the actuating forces of the drive means and their movement speeds are in complete correspondence, so that these physical parameters have an immediate effect on all of the clamping jaws present. Herein, the synchronizer ring is supported in the chuck body so as to be rotatable about the longitudinal axis thereof, so that the axial movements of the drive means are converted into a rotational movement of the synchronizer ring.

In order to obtain the usual connection between the respective drive means and the synchronizer ring, a gearing is provided at the outer surface of the synchronizer ring for each of the drive means, which engages into a gearing related to the respective drive means, so that a positive operative interaction is provided between the respective drive means and the synchronizer ring. The drive means that are present and the synchronizer ring accordingly form some sort of gearing mechanism for synchronisation of the feed forces, the feed speeds and for adjusting the clamping forces required.

Moreover, it is often necessary that the clamping movements of the clamping jaws are adjusted to one another. If a workpiece is to be clamped, whose cross-sectional shape is not rotation-symmetric, in the case that, for example, the workpiece has a rectangular shape, two of the opposed clamping jaws contact the outer contour of the workpiece earlier than the two clamping jaws that are arranged perpendicular thereto. Consequently, the feed movement of the first pair of clamping jaws has to be stopped until the second pair of clamping jaws contacts the workpiece. Such compensatory movement can be implemented by operatively connecting two adjacent clamping jaws by means of a rocker. Herein, the rocker is mounted to the chuck body in a manner to be pivotable around a pivot pin. As soon as one of the clamping jaws strikes the workpiece, a torque is generated, which has a unilateral effect on the rocker that causes it to pivot into the direction of the interior of the chuck body. The clamping jaw that is not yet in contact with the workpiece may accordingly be moved further radially and be fed without the clamping jaws already in contact exercising any clamping force onto the workpiece. Not until all of the clamping jaws simultaneously contact the outer contour of the workpiece, i.e. not until these are in operative contact therewith, is a clamping force generated due to the further axial movement of the drive means, which is further transmitted by the clamping jaws onto the workpiece to be secured.

By means of such movements of adjustment of the clamping jaws, i.e. the rockers connecting such clamping jaws, the workpiece to be clamped may be aligned exactly coaxially to the longitudinal axis of the chuck body. This longitudinal axis of the chuck body must be considered to be the centering axis for processing the workpiece as this centering axis serves as a reference for the machining tool. After all, the control programs recorded in the machine tool exactly know the position and the extension of the centering axis, so that the individual working steps with regard to the workpiece to be clamped can be carried out.

The drawings show an exemplary embodiment of a chuck with two drive alternatives which is explained in more detail in the following. What is shown is:

### BRIEF DESCRIPTION OF THE DRAWINGS

FIG. 1 a chuck having two mechanical drive means, which is mounted on a tool table associated with a machine tool, comprising four clamping jaws that retain a workpiece to be machined coaxially with regard to a centering axis, in a perspective view,

FIG. 2a the chuck according to FIG. 1 with the clamping jaws in an open state and in a cross-sectional view,

FIG. 2b the chuck according to FIG. 2a with the clamping jaws in a clamped state,

FIG. 3a the chuck according to FIG. 1 provided with the two drive means arranged perpendicularly to the centering axis and moving the four clamping jaws synchronously, with the clamping jaws being in an open state,

FIG. 3b the chuck according to FIG. 3a with the clamping jaws in a clamped state,

FIG. 4a the chuck according to FIG. 1 along a cutting line in parallel to the X axis,

FIG. 4b the chuck according to FIG. 1 along a cutting line parallel to the Y axis,

FIG. 5 a cutting plane according to FIG. 1 in a plan view onto the plane formed by the X and the Y axis,

FIG. 6a the chuck according to FIG. 1 in an open state, in a perspective view,

FIG. 6b the chuck according to FIG. 6a, in a clamped state,

FIG. 7a the chuck according to FIG. 6a illustrating a compensating rocker, the rocker being in a horizontal state,

FIG. 7b the chuck according to FIG. 6b illustrating a compensating rocker, the rocker being in a pivoted state,

FIG. 8 the chuck according to FIG. 1 in an exploded view, and

FIG. 9 the chuck according to FIG. 1 provided with an electric motor as a drive means for the actuation of the clamping jaws.

### DETAILED DESCRIPTION OF THE PREFERRED EMBODIMENTS

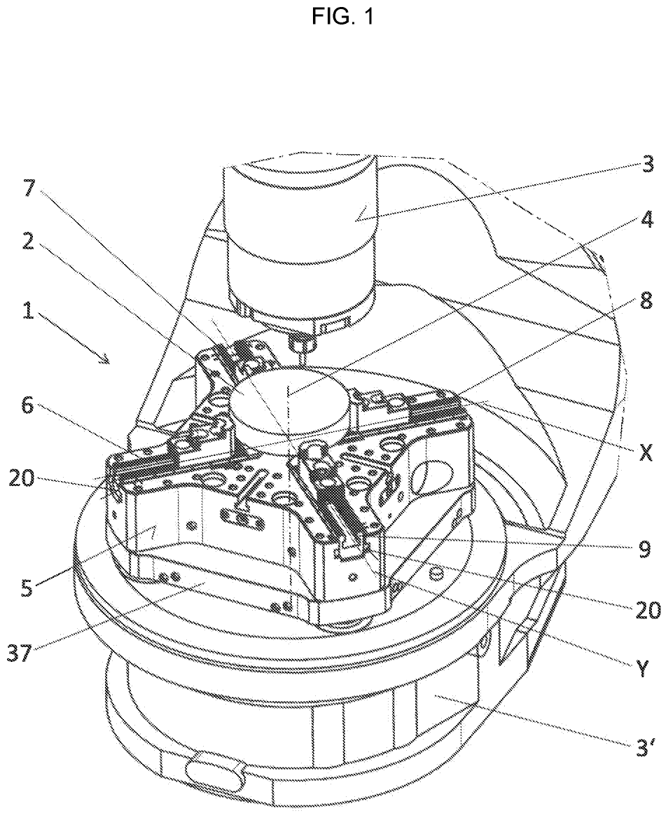

FIG. 1 illustrates a chuck 1 for retaining a workpiece 2 at a machine tool table 3′ associated with a machine tool 3. The workpiece 2 may have any desired outer contour, in particular a rotation-symmetrical, rectangular or elliptical outer contour. The workpiece 2 is supposed to be machined by the machine tool 3. In order to reach clamping positions with an utmost repeat accuracy and in an utmost centered manner for identical workpieces 2, a centering axis 4 is defined which, in the embodiment illustrated, corresponds to the longitudinal axis of the chuck 1. The centering axis 4 serves as a reference for the machine tool 3, so that all of the steps of machining the workpiece 2 can be carried out starting from the centering axis 4. The position of the chuck 1 at the tool table 3′ remains unchanged so that its centering axis 4 does not change in respect to the position of the machine tool 3 and whenever identical workpieces 2 are replaced, their respective axis of symmetry extends coaxially as to the centering axis 4.

Accordingly, each of the workpieces 2 to be clamped is supposed to be retained centered at the chuck 1 in such a manner that the axis of symmetry of the workpieces 2 to be clamped is aligned or extending coaxially with respect to the centering axis 4.

In order to enable such centred clamping of the workpiece 2, the chuck 1 comprises a chuck body 5 into which, in the illustrated embodiment, four guide grooves 20 are incorporated. The guide grooves 20 herein are oriented in the direction of the centering axis 4 and thus extend radially. Moreover, the guide grooves 20 are open upwardly so that one clamping jaw 6, 7, 8 or 9 can be inserted into each of the guide grooves 20. Each of the four clamping jaws 6, 7, 8, 9 is movably supported in the respective guide groove 20 so that each of the clamping jaws 6, 7, 8, 9 can be fed in the direction of the centering axis or away from it. The surface of the chuck body 5 between the guide grooves 20 serves as a support 5′ for the workpieces 2 to be clamped.

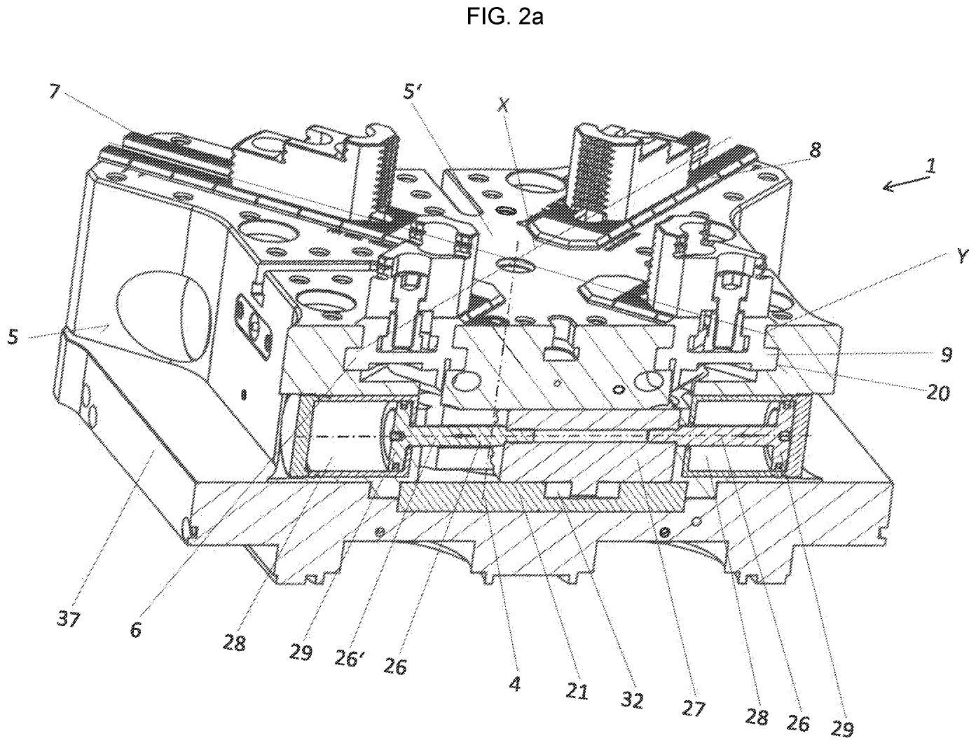

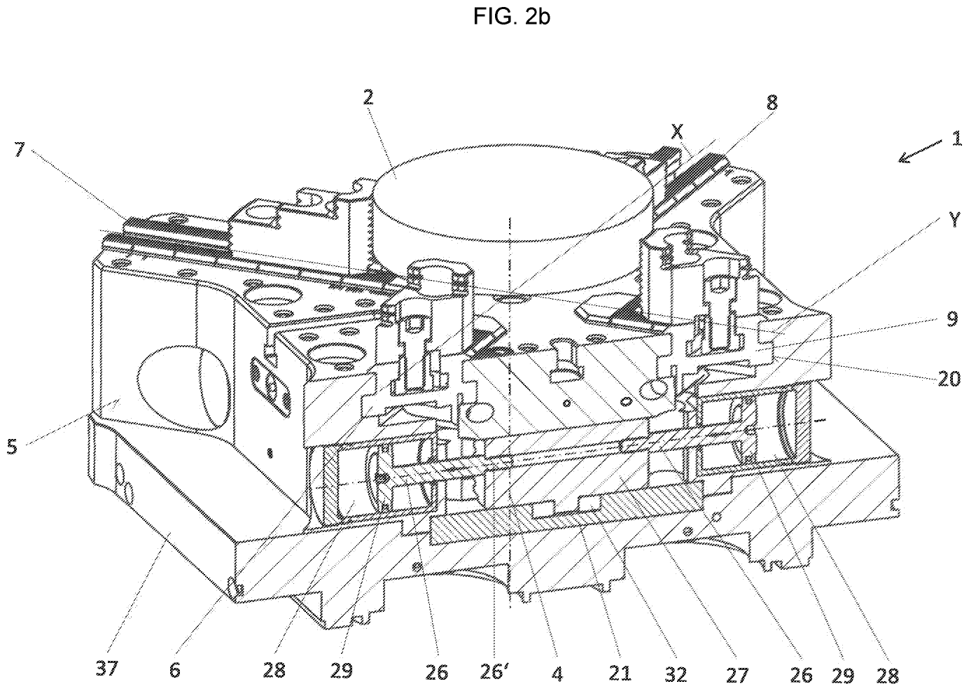

According to FIGS. 2a and 2b, inside the chuck body 5 there are different functional levels I, II, III and IV that are described in more detail in the following.

Functional level I comprises a synchronizer ring 21 that is centrically arranged around the centering axis 4. The synchronizer ring 21 positively and operatively interacts with the respective drive means 12, 13 and is rotatably supported within the chuck body 5.

A third functional level III comprises a compensatory self-aligning bearing in the form of a rocker 18.

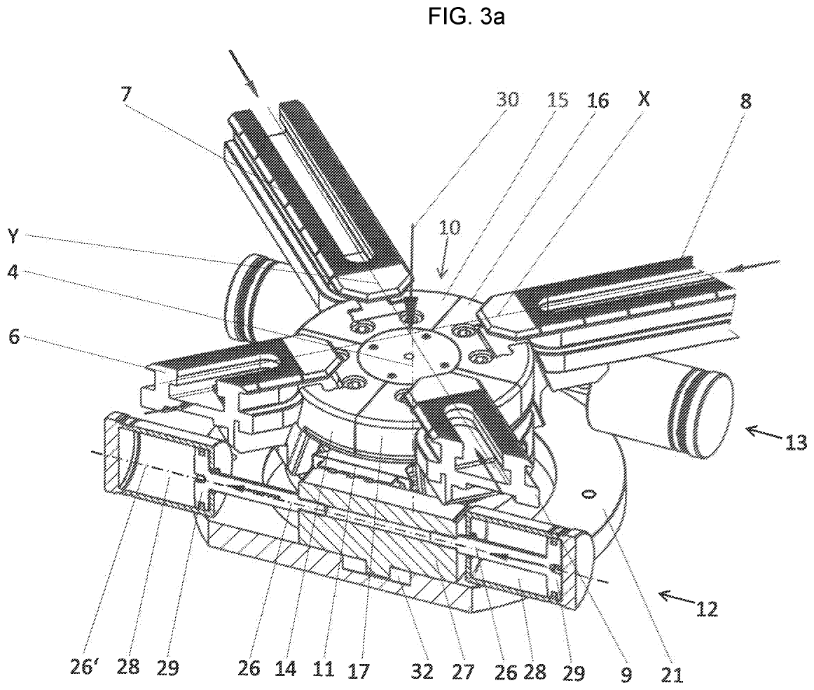

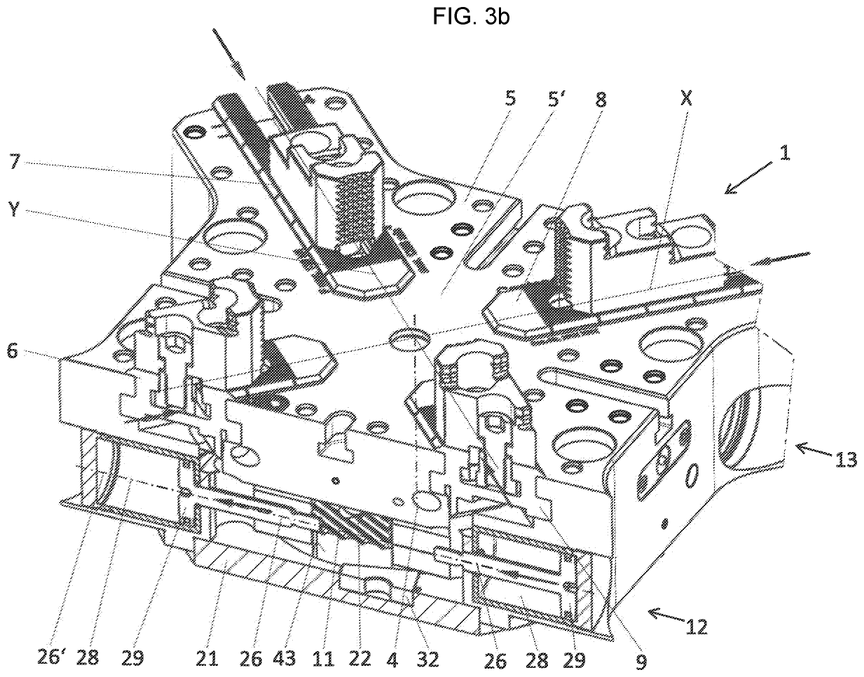

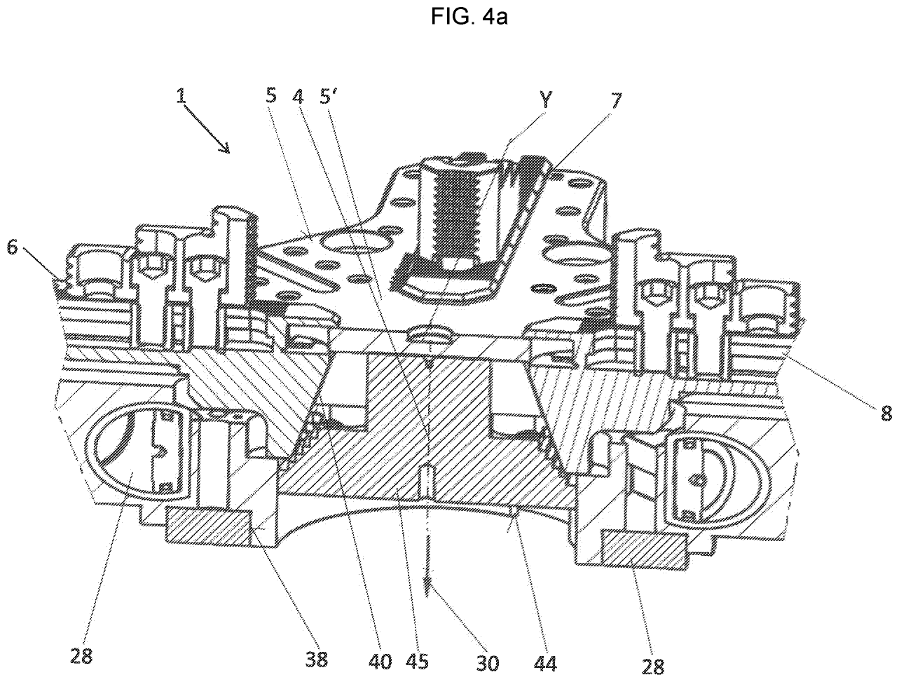

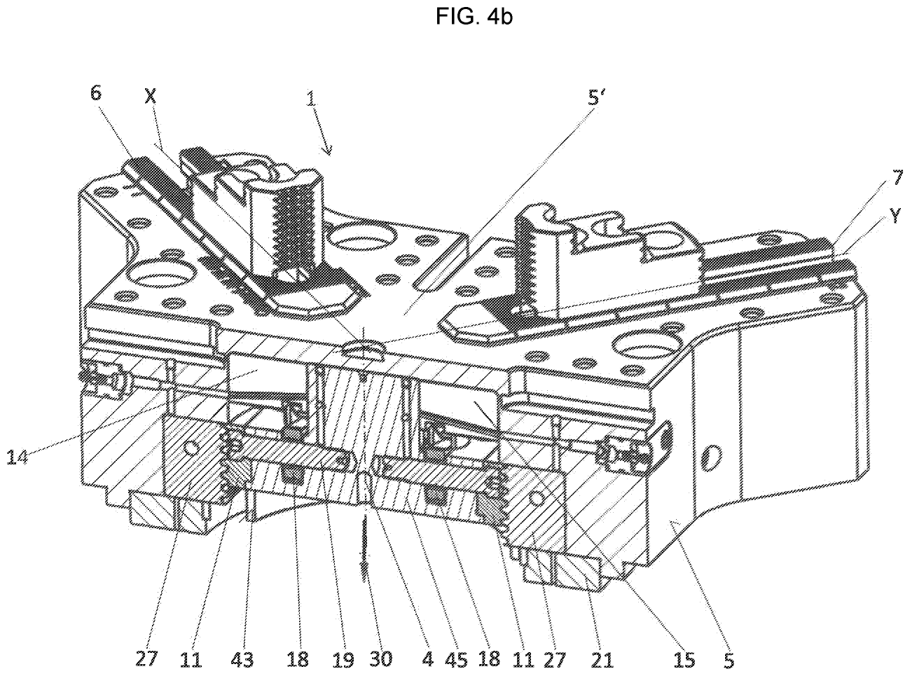

First, with a view to FIGS. 3a, 3b and 4, the motion sequence for actuation of the four clamping jaws 6, 7, 8 and 9 through the two drive means 12, 13 is to be described.

As the drive means 12 and 13 are arranged in parallel to one another and opposite to the centering axis 4, it is technically necessary to actuate the drive means 12 and 13 in opposite directions in order to achieve the synchronous movement of the clamping jaws 6, 7, or 8, 9 coupled thereto in pairs.

As a first drive alternative, the drive means 12 and 13 are designed to constitute hydraulically or pneumatically driven pressure pistons and therefore have respective stroke and pressure chambers 28, into which a respective medium can be alternately pressed in or out through corresponding valve openings A, B. The stroke/pressure chambers 28 are divided by a pressure plate 29, whose axial displacement generates the traction force represented by reference numeral 30. The control mechanism of the drive means 12 and 13 is conventionally known so that it can be technically assumed that the control assigned to the respective movement of the drive means 12 and 13 takes place by pressing in and pressing out the provided medium.

Consequently, the motion sequences for feeding the clamping jaws 6, 7, 8 and 9 can be inferred from FIGS. 1, 2a, 2b, 3a and 3b. Herein, the clamping jaws 6, 7, 8 and 9 inserted into the guide grooves 20 are coupled to the drive piston 10 via wedge hook frames 40. A transmission plate 11 is mounted to the drive piston 10, which has outwardly oriented gearings 22 assigned to a piston rod 26, which is related to one of the drive means 12 or 13 that are connected to one another via the coupling part 27. Consequently, whenever the hydraulic pistons as a substantial part of the drive means 12 or 13 are accordingly controlled through the valve openings A and B and the respective stroke/pressure chamber 28 is accordingly filled with or emptied from the medium, first, the piston rod 26 linearly moves into the correspondingly predetermined direction. As the coupling rod 26 is connected with the coupling part 27 and the helical gearing of the coupling part 27 is connected to both the synchronizer ring 21 and the wedge hook connection 40, the respective sliding blocks 14 to 17 are moved radially into the direction of the centering axis 4 by the traction force 30 acting upon the pull piston 45 that is moved downwards.

Furthermore, the piston rod 26 has a longitudinal axis 26′ which is aligned to be perpendicular to the centering axis 4. Preferably, the support 5′ is perpendicular in respect to the centering axis 4 and the longitudinal axis 26′ extends in parallel to the support 5′.

As the clamping jaws 6, 7, 8 and 9 are radially guided within the guide groove 20 and due to the helical gearing between these and the sliding blocks 14 to 17, a radial feed movement in the direction of the centering axis 4 is generated or the four clamping jaws 6, 7, 8, 9 are moved outwardly from the centering axis 4. Through the drive means 12 and 13, the drive piston 10 is pulled downwards by a traction force 30 according to FIG. 4, so that the four clamping jaws 6, 7, 8 and 9 are moved radially in the respective guide groove 20 in accordance with the explanations given above.

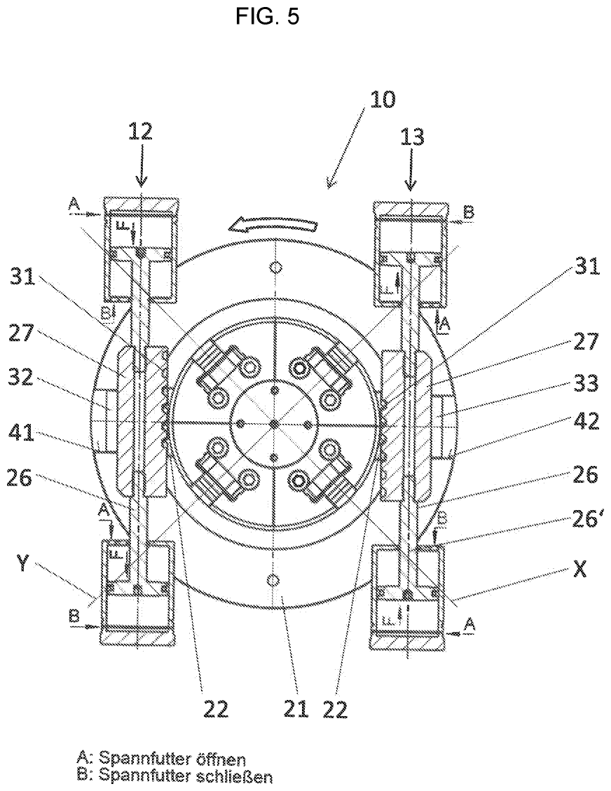

In the case of two or more drive means 12 and 13 being provided it is preferrable that, for synchronising the mutual movements, the movements of the drive means 12 and 13 are synchronised. Such adjustment of movement between the two drive means 12 and 13 is effected by the synchronizer ring 21 shown in FIG. 5. To this end, the synchronizer ring 21 has two guide grooves 41, 42 each of which positively encompasses a sliding block 32 and 33. The sliding blocks 32, 33 are assigned to a coupling part 27, which is fixedly connected with the respective drive means 12 or 13. The coupling part 27 moves along with the respective drive means 12 or 13 and the synchronizer ring 21 correspondingly represents some kind of gearing for the adjustment of movement of the two drive means 12 or 13. Whenever one of the drive means 12 or 13 is moved quicker or more slowly due to the filling of the stroke/pressure chamber 28, then the synchronizer ring 21 compensates for the differences in motion speeds or motion forces of the drive means 12 and 13. Consequently, the drive piston 31 is drivingly coupled through both of the drive means 12 and 13 and the synchronizer ring 21 due to the helical gearings 22, 23.

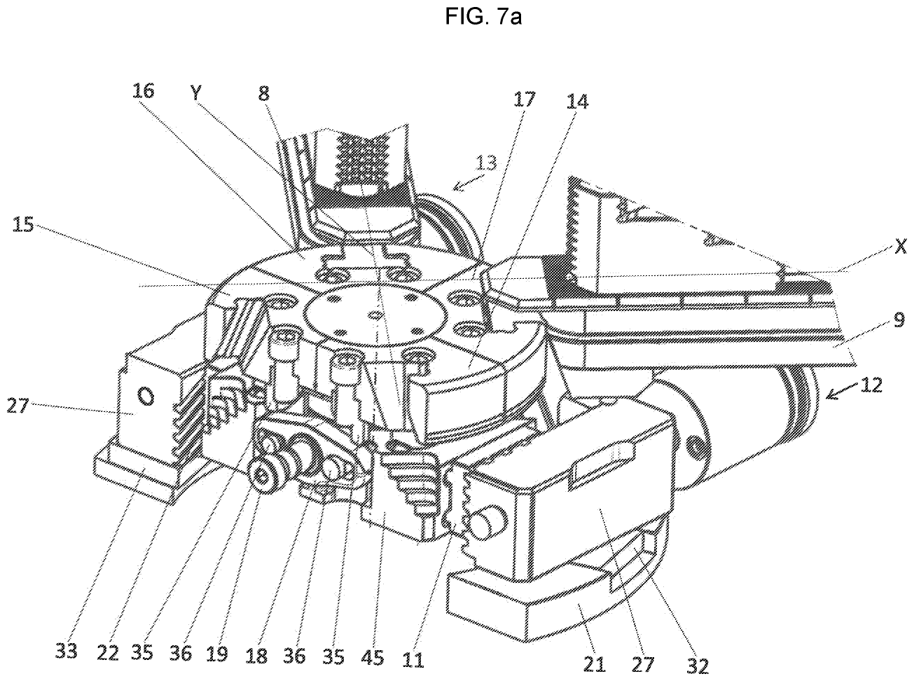

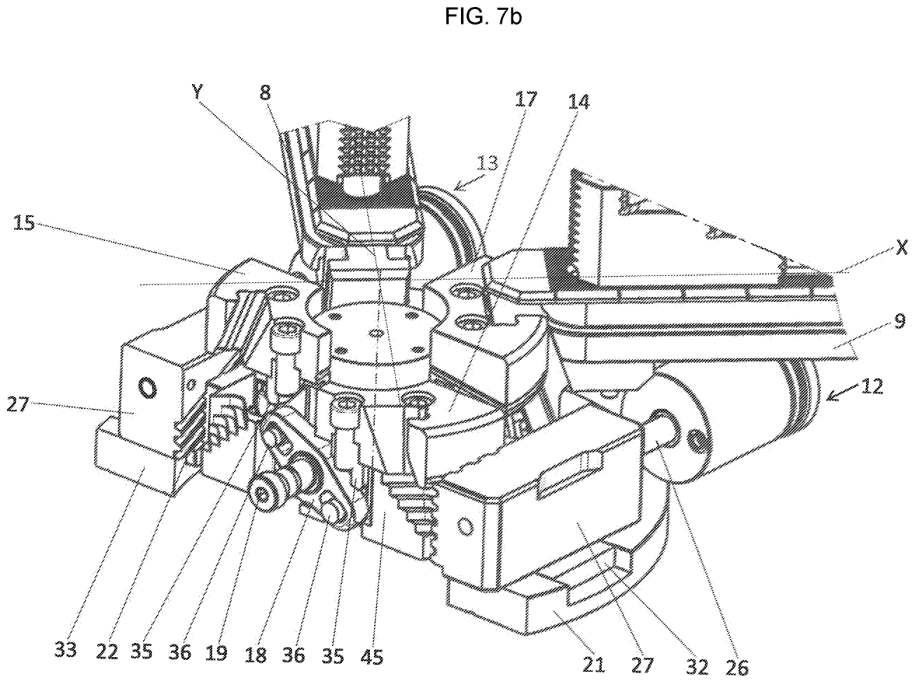

Moreover, it can be inferred from FIGS. 7a, 7b that inside the drive piston 10, four compensatory self-aligning bearings in the form of a rocker 18 are provided. Via a bearing pin 19, the respective rocker 18 herein is connected to the drive piston 10 in a rotatable or pivotable manner and two respective adjacent clamping jaws 6, 7 or 8, 9 are connected to one of the two free faces of the rocker 18 via a sliding block 14, 15, 16 or 17. Thus, the drive pistons 10 form a construction unit with the sliding blocks 14, 15, 16, 17.

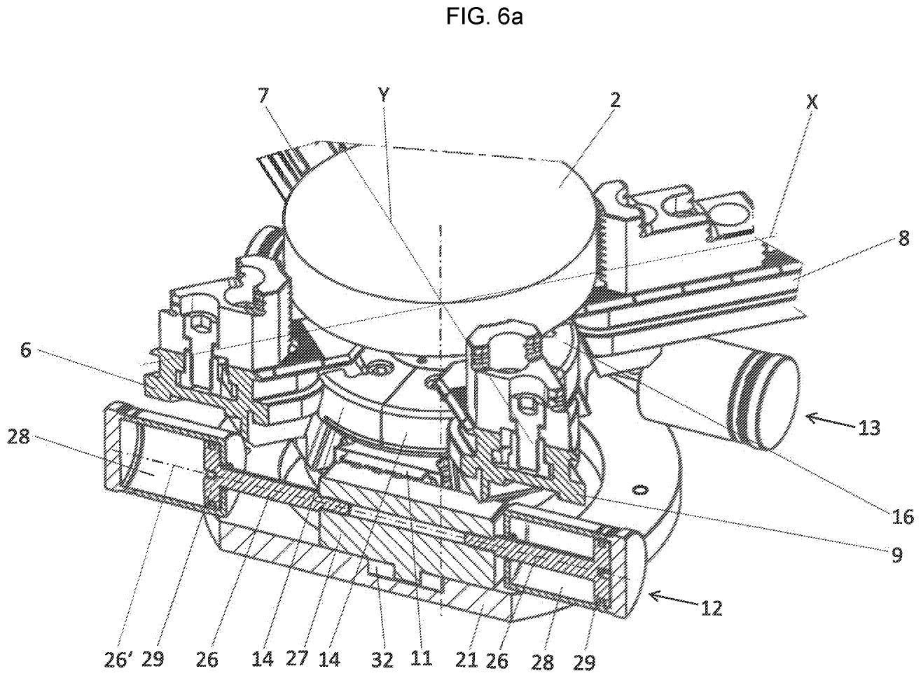

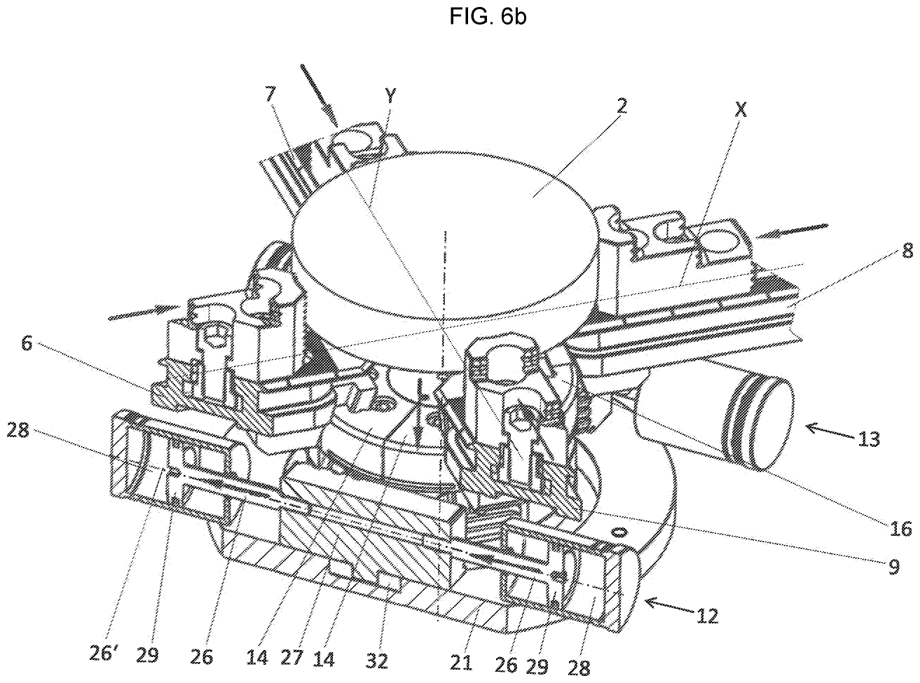

According to FIGS. 6a and 6b a movement compensation is supposed to take place whenever two opposed clamping jaws 6, 8 or 7, 9 come into operative contact with the workpiece 2 earlier than the adjacent clamping jaws 7, 9 or 6, 8. In the case of rectangular workpieces 2, the lengths of the edges are different, so that the time of contact of the four clamping jaws 6, 7, 8, 9 is different for each of the pairs. As soon as a first pair of clamping jaws 6, 8 comes into operative contact with the workpiece 2, the actuating forces are further maintained or preserved by the drive means 12, 13 and the two other clamping jaws 7 and 9 are still spaced apart from the surface of the workpiece 2 to be clamped, a movement compensation is to be effected through the rockers 18. Herein, the rockers 18 pivot about the bearing pin 19, so that these movements are stopped at the clamping jaws 6, 8 resting upon the workpiece 2 and the two other clamping jaws 7, 9 are further fed in the direction of the workpiece 2. Only when all of the four clamping jaws 6, 7, 8 and 9 are in operative contact with the workpiece 2 is the actual clamping process effected as the pivoting movement of the rockers 18 is terminated and due to the helical gearings between the drive means 12, 13 and the clamping jaws 6, 7, 8 and 9, a clamping force is generated through which the workpiece 2 is held.

Due to the compensatory movement described above through the respective rocker 18 between two neighbouring clamping jaws 6, 7, 8, and 9 thus a synchronisation of movement is performed in feeding the clamping jaws 6 to 9, so that not only workpieces 2 having different edge lengths but also workpieces 2, which are first supported unsymmetrically on the support surface 5′ of the chuck body 5, can be aligned coaxially to the centering axis 4. This is due to the fact that the four clamping jaws 6, 7, 8 and 9 push the workpiece 2 into the center of the chuck body 5 so that the axis of symmetry of the workpiece 2 is displaced and aligned coaxially to the centering axis 4.

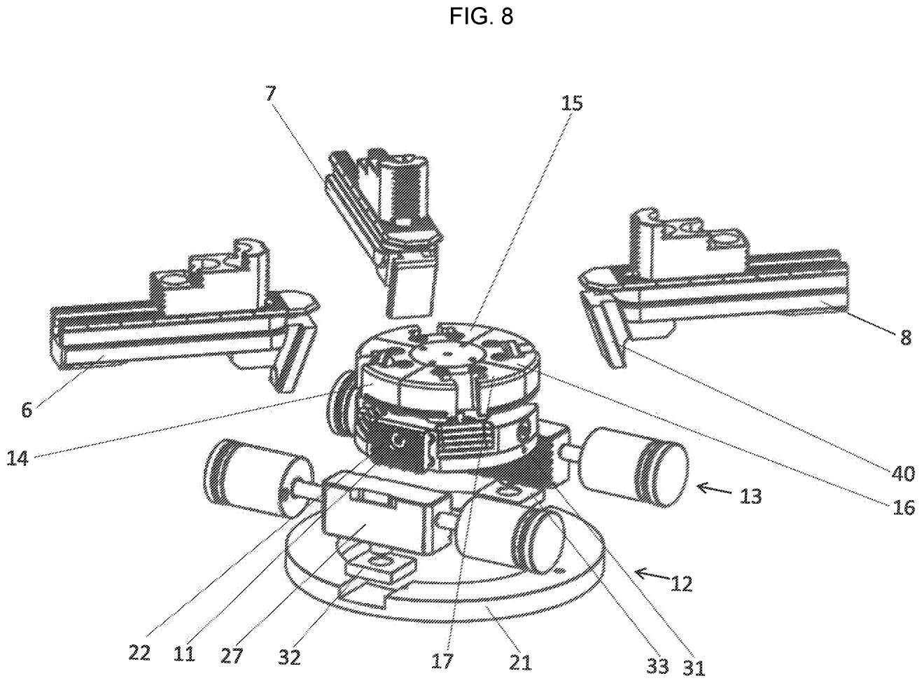

From FIGS. 7a, 7b to 8 the mechanical connections between the clamping jaws 6, 7, 8 and 9, the drive means 12, 13 and the rocker 18 are shown. As soon as the rocker 18 is pivoted about the bearing pin 19 in one direction in accordance with FIG. 7b, one of the sliding blocks 14, 15, 16 or 17 moves downwards in parallel to the centering axis 5 and the corresponding feed movement of the clamping jaws 6, 7, 8 or 9 mounted thereto is terminated during such process of the rocker 18 and a clamping force is generated only after all of the four clamping jaws 6, 7, 8, 9 rest against the outer contour of the workpiece 2 to be clamped.

The four functional levels I, II, III and IV differ from one another as follows. Functional level I comprises the driving operative connection between the synchronizer ring 21 and the respective drive means 12 and 13. The sliding blocks 32 and 33 mounted to the coupling part 27 are positively coupled to the synchronizer ring 21. Such operative connection ensures that both the actuating forces of the drive means 12 and 13 and their movement speed exactly correspond to one another.

Functional level II is formed by a helical gearing 22 incorporated to the coupling part 27 and operatively connected to the synchronizer ring 21. Through the opposite linear movements of the drive means 12 and 13 the gearing 22, provided at the respective coupling part 27 and engaging the helical gearings 22 of the drive piston 10 or the transmission plate 11, generates the operative connection to the axial up and down movement of the drive piston 10. The drive piston 10 therein is secured against twisting in the guide grooves 43 and 44.

Functional level III refers to the compensatory mechanisms in the form of the rocker 18 and its assigned components provided inside the drive piston 10 as the free faces of the rocker 18 are respectively connected by means of a transmission pin 34, 35 to those of the sliding blocks 14 to 17, which are mounted to the rocker 18 so as to be rotatable around a head 36. An overall number of four rockers 18 are provided, each of which is supported to be rotatable or pivotable about the bearing pin 19 in the drive piston 10. To both faces of the rocker 18 sliding blocks 14, 15, 16 and 17 are mounted. By pivoting the rockers 18 to one side, the sliding blocks 14, 15, 16 and 17 axially move up and down. The connection between the rockers 18 and the sliding blocks 14, 15 or 16 and 17 generate a synchronized up and down movement of the sliding blocks 14, 15, 16 and 17 in pairs. Consequently, the opposite sliding blocks 14 and 16 or 15 and 17 move in a synchronous manner. Thus, the pull piston 45, the rockers 18, the bearing pins 19 and the sliding blocks 14, 15, 16 and 17 form the construction unit of the drive piston 10.

Functional level IV is formed by the operative mechanism of the sliding blocks 14, 15, 16 and 17 and the clamping jaws 6, 7, 8 and 9, which are drivingly coupled to one another via the wedge hook frame 40. Owing to the axial movements of the sliding blocks 14, 15, 16 and 17, a movement of the clamping jaws 6, 7, 8 and 9 radially to the centering axis 4 in a feed direction or moving away therefrom is generated.

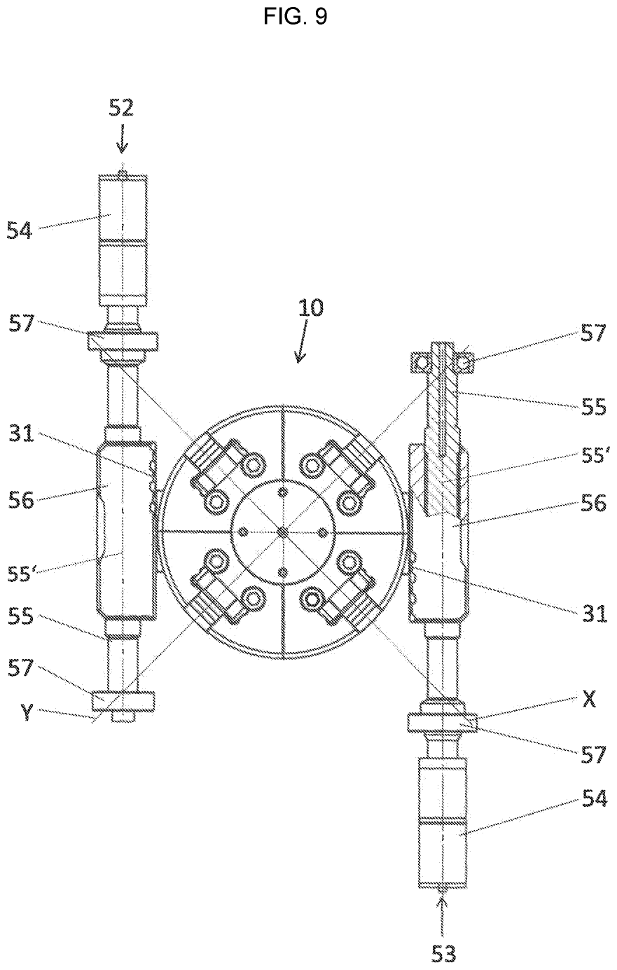

In FIG. 9, an alternative drive for moving the clamping jaws 6, 7, 8 and 9 is shown. Herein, the pressure pistons are replaced by an electric motor 54. The drive means are referred to by reference numerals 52 and 53. The respective electric motor 54 herein is moveable in two angle directions, i.e. in a clockwise or an anti-clockwise direction.

The respective electric motor 54 is movable by means of a threaded spindle 55 that is rotatably supported in a spindle bearing 57 to be rotatable around its longitudinal axis 55′. Herein, the spindle bearing 57 is incorporated into the chuck body 5. Accordingly, the threaded spindle 55 may exclusively rotate about its longitudinal axis 55′. At the exterior of the threaded spindle 55 a coupling part 56 is provided that is translated from a rotation of the threaded spindle 55 into a linear movement. Herein, the coupling part 56 is supported so as to be axially movable within the chuck body 5 and the rotation movements of the threaded spindle 55 are converted into axial movements of the coupling part 56 in a conventional manner. The coupling part 56 is provided with corresponding gearings 31, which are mechanically and operatively connected to the synchronizer ring, i.e. the drive piston 10.

Accordingly, as soon as the electric motor 54 is translated into a predetermined direction of rotation, the threaded spindle 55 rotates about its longitudinal axis 55′ so that the coupling part 56 is translated into a linear movement. Further mechanical feed forces and motion sequences inside the chuck body 5 correspond to FIGS. 1 to 8.

Both drive alternatives have in common that the piston rod 26 and the threaded spindle 55 extend or are aligned perpendicular to the centering axis 4. Thus, it is ensured that for generating and transmitting the required movement forces no constructive space is required that extends in parallel to the centering axis and thus substantially increases the constructive height of the chuck body 5.

What is claimed is:

1. A chuck (1) by means of which workpieces (2) are supported individually for machining by a machine tool (3) and aligned coaxially to a centering axis (4), which serves as a reference for machining the workpiece (2) by the machine tool (3),
having a chuck body (5),
having at least four clamping jaws (6, 7, 8, 9) that are radially movably mounted on the chuck body (5) and are each arranged in pairs in an X or Y plane and by means of which the workpiece (2) is held during the machining process to be aligned with respect to the centering axis (4),
and having a pull piston (45) that is mounted in or at the chuck body (5) so as to be linearly movable and which is drivably coupled to a respective clamping jaw (6, 7, 8, 9) such that during the linear movement of the pull piston (45) the clamping jaws (6, 7, 8, 9) are radially fed in the direction of the workpiece (2) to be clamped or moved away from same in a synchronous manner,
wherein the pull piston (45) is arranged coaxially with respect to the centering axis (4) inside the chuck body (5) and is axially actuated by one or more drive means (12, 13, 52, 53),
characterised in that
each of the drive means (12, 13, 52, 53) has a linearly movable piston rod (26) or threaded spindle (55), whose respective longitudinal axis (26′ or 55′) is arranged to be perpendicular with respect to the centering axis (4).

2. The chuck according to claim 1,
characterised in that
within the chuck body (5) a construction unit is provided consisting of one of the sliding blocks (14, 15, 16, 17) assigned to and coupled with one respective of the clamping jaws (6, 7, 8, 9) and a rocker (18), which is supported at the chuck body (5) and pivotable about a bearing pin (19) and by means of which two respective neighbouring sliding blocks (14, 15 or 16, 17) are drivingly coupled with one another.

3. The chuck according to claim 1,
characterised in that
two of the drive means (12, 13 or 52, 53) are arranged in parallel to one another and spaced apart from the centering axis (4) on the outside of the chuck body (5) or inside of it.

4. The chuck according to claim 3,
characterised in that
inside the chuck body (5), a synchronizer ring (21) is rotatably supported, that the synchronizer ring (21) has at least two guide grooves (41, 42) and that a coupling part (27) is mounted to each of the drive means (12, 13; 52, 53) and that a sliding block (32, 33) is formed to each coupling part (27), which positively engages or is inserted into the guide grooves (41, 42) of the synchronizer ring (21).

5. The chuck according to claim 2,
characterised in that
each of the sliding blocks (14, 15, 16, 17) is drivingly coupled to one of the clamping jaws (6, 7, 8, 9).

6. The chuck according to claim 4,
characterised in that
the sliding blocks (32, 33) of the synchronizer ring (21) are supported to be coaxial with respect to the centering axis (4) in the chuck body (5) and to be movable with respect thereto.

7. The chuck according to claim 1,
characterised in that
the drive means (12, 13) are designed to be a hydraulically driven pressure piston having a piston rod (26) and in that the drive means (52, 53) are designed to be an electric motor (54) and a threaded spindle (55) drivingly coupled thereto, each of which are mounted to the coupling part (27).
